(19) United States
(12) Patent Application Publication
(10) Pub. No.: US 2015/0159755 A1
(43) Pub. Date: Jun. 11, 2015

(54) JACKETED RESILIENT METAL SEAL

(71) Applicant: Technetics Group, LLC, Charlotte, NC (US)

(72) Inventors: Mark S. Whitlow, Columbia, SC (US); Jason Adams, Columbia, SC (US); Kevin Lamb, Columbia, SC (US); John Harr, Columbia, SC (US); Kenneth Richards, Columbia, SC (US); Caleb Garrison, Columbia, SC (US)

(73) Assignee: Technetics Group, LLC, Charlotte, NC (US)

(21) Appl. No.: 14/400,496

(22) PCT Filed: May 16, 2013
(86) PCT No.: PCT/US13/41429

§ 371 Date: Nov. 11, 2014

Related U.S. Application Data
(60) Provisional application No. 61/648,460, filed on May 17, 2012.

(51) Int. Cl. F16J 15/08; F16L 23/20; F16J 15/10

(52) U.S. Cl. CPC F16J 15/08; F16J 15/104; F16L 23/20

(57) ABSTRACT

A resilient metal seal that includes a PTFE jacket or liner capable of improving the sealing performance of the resilient metal seal and providing a near chemically inert surface to protect the seal from coming into contact with potentially damaging media is provided. In some embodiments, the resilient metal seal is an E-, U-, C-, or V-shaped resilient metal seal. A jacket made of PTFE or similar material can be included on the interior or exterior surface of the resilient metal seal. The jacket can include a locking feature to prevent against the jacket becoming dislodged from the resilient metal seal.

### PRIORITY

The present application claims priority to U.S. provisional patent application Ser. No. 61/648,460, titled JACKETED RESILIENT METAL SEAL, filed May 17, 2012, the disclosure of which is incorporated by reference as if set out in full.

### BACKGROUND

Metal seals often use soft metal platings or coatings to enhance sealing performance. The high ductility of soft metals such as silver allows for increased plastic deformation at the interface of the metal seal and the flanges to be sealed, which thereby enhances sealing performance. However, when the seal to be coated is a resilient metal seal, such as an E-seal, U-seal, or V-seal, the resilient metal seal often does not produce enough contact load to plastically deform the soft metal coating, resulting in inconsistent sealing performance. Soft metal coatings also can be difficult to apply to resilient metal seals having relatively complex geometries, such as in the case of E-seals. Moreover, soft metal coatings may not offer the same degree of corrosion protection or chemical inertness as is offered by other materials typically used in metal sealing applications, such as, for example, polytetrafluoroethylene (PTFE) and similar polymers.

Typical spring-energized PTFE seals rely on various spring configurations for resiliency and to provide contact load necessary to effect a seal. These geometries can include helically-wound springs or cantilever (or finger) springs as illustrated in FIG. 1. However, these spring designs provide little sealing benefit without the presence of a jacket. In extreme conditions, such as those when the jacket is compromised, the remaining spring structure does not provide adequate protection against leakage because of the general open (i.e., non-continuous) configuration of the spring design.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Described herein are embodiments of a resilient metal seal that includes a PTFE jacket or liner capable of improving the sealing performance of the resilient metal seal and providing a near chemically inert surface to protect the seal from coming into contact with potentially damaging media. In some embodiments, the resilient metal seal is an E-, U-, C-, or V-shaped resilient metal seal. A jacket made of PTFE or similar material can be included on the interior or exterior surface of the resilient metal seal. The jacket can include a locking feature to prevent against the jacket becoming dislodged from the resilient metal seal.

These and other aspects of the present system will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is an illustration of spring-energized seals known in the prior art.

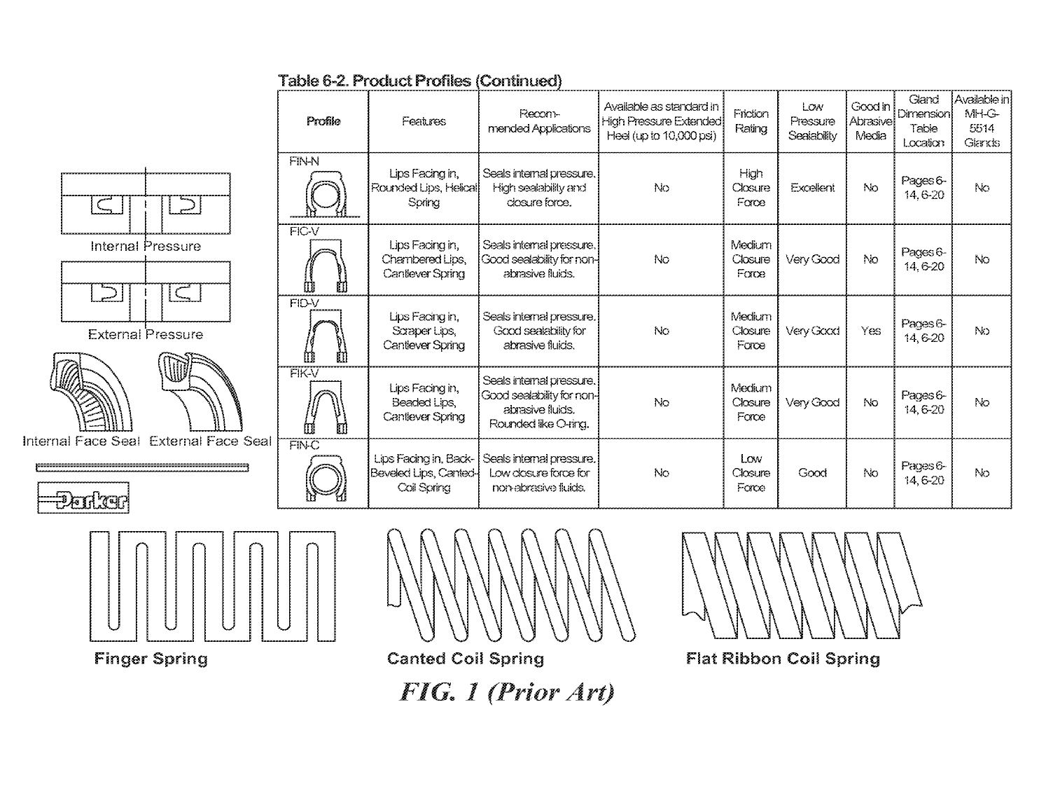

FIG. 2 is a cross-sectional perspective view of a jacketed resilient metal seal according to embodiments described herein.

FIG. 3 is a cross-sectional perspective view of a jacketed resilient metal seal according to embodiments described herein.

FIG. 4 is a cross-sectional perspective view of a jacketed resilient metal seal according to embodiments described herein.

FIG. 5 is a cross-sectional perspective view of a jacketed resilient metal seal as described herein positioned between flanges.

FIG. 6 is a cross-sectional perspective view of a jacketed resilient metal seal as described herein including a fully encapsulated jacket.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

The jacketed resilient metal seal generally includes a resilient seal made from a suitable metal material and a jacket or liner shielding an exterior or interior surface of the resilient metal seal. In this application, the interior surface of the seal refers to the surface of the seal facing towards the center of the seal and may define the inner diameter of the seal, while the exterior surface refers to the surface of the seal facing away from the center of the seal and may define the outer diameter of the seal. In other words, the embodiments described herein relate to an internally facing seal where the higher pressure is internal to the seal. However, the technology of the present application is applicable to an externally facing seal as well where the higher pressure is external to the seal.

The resilient metal seal may have any shape known in the art to be suitable for resilient metal seals, including E-, U-, V-, and C-shaped resilient metal seals. The resilient metal seals generally exhibit elasticity in the axial direction such that when the seal is compressed between, e.g., flanges, the surfaces of the seal in contact with the flange surfaces bend towards the center of the seal. The elasticity of the open end of the seal forces the sealing surfaces to form a seal with the flange surfaces. In some configurations, such as with E-shaped resilient metal seals, other portions of the seal not in direct contact with the flanges also bend when the seal is compressed between flanges. The seal preferably experiences no or minimal permanent deformation as a result of the compression between flanges and will revert back to its original position if the compression between flanges is discontinued. The elasticity of the resilient seal helps to enhance sealing performance by virtue of the seal pushing back against the flanges when compressed between the flanges.

The resilient metal seal can be made from any suitable metal material that will exhibit the desired level of elasticity. Typical metals used in the manufacture of resilient metal seals include, but are not limited to, high strength, nickel-based alloys such as Alloy 718 and Alloy X-750. These materials are chosen in part due to ease of fabrication and the ability to strengthen the formed parts through heat treatment.

While the cross-section of the seal is generally as described above (e.g., E-, C-, U, or V-shaped), the overall seal has a generally annular shape so that the seal can form an appropriate radial barrier between flanges. The dimensions of the inner and outer diameter of the seal are generally not limited and can be selected based on the application of the seal. Similarly, the thickness of the seal is not limited and can be adjusted based on the application of the seal.

The resilient metal seal includes a jacket or liner to help improve sealing performance and provide a protective layer. The jacket can be an interior jacket, meaning it protects primarily the interior surface of the seal, or an exterior surface jacket, meaning it protects primarily the exterior surface of the seal. In some embodiments, the seal can include both an interior and an exterior jacket, including a unitary jacket that encapsulates the entire seal and thereby protects both the exterior and interior surface. In addition to providing a barrier layer between potentially damaging media and the resilient metal seal, the jacket also provides improved sealing performance. The jacket is designed to conform to the surface of the mating flanges when compressed between flanges, which thereby helps form a better seal and eliminate any potential leak passageways.

The material of the jacket can generally include any material that will provide chemical inertness and protection against corrosive materials, while also helping to improve the sealing performance of the resilient seal to which it is coupled. In some embodiments, the jacket is made from PTFE. Other materials similar to PTFE which can also be used include, but are not limited to, perfluoroalkoxy (PFA), fluorinated ethylene propylene (FEP), ultra high molecular weight polyethylene (UHMWPE), and perfluoroelastomers. PTFE and similar materials provide the seal with the desired level of protection against various media while also conforming to the surface of the mating flanges to help create a better seal between flanges.

The jacket will generally have a cross-sectional shape that mirrors the cross-sectional shape of the seal. For example, when the resilient seal has a C-shape, the jacket can also have a C-shape. In the case of an E-shaped resilient seal, the jacket will generally have a C-shape, although E-shapes can also be used. The dimensions of the jacket are generally selected so that the jacket fits closely with the resilient seal when the two elements are coupled. The thickness of the jacket can be varied based on application of the seal.

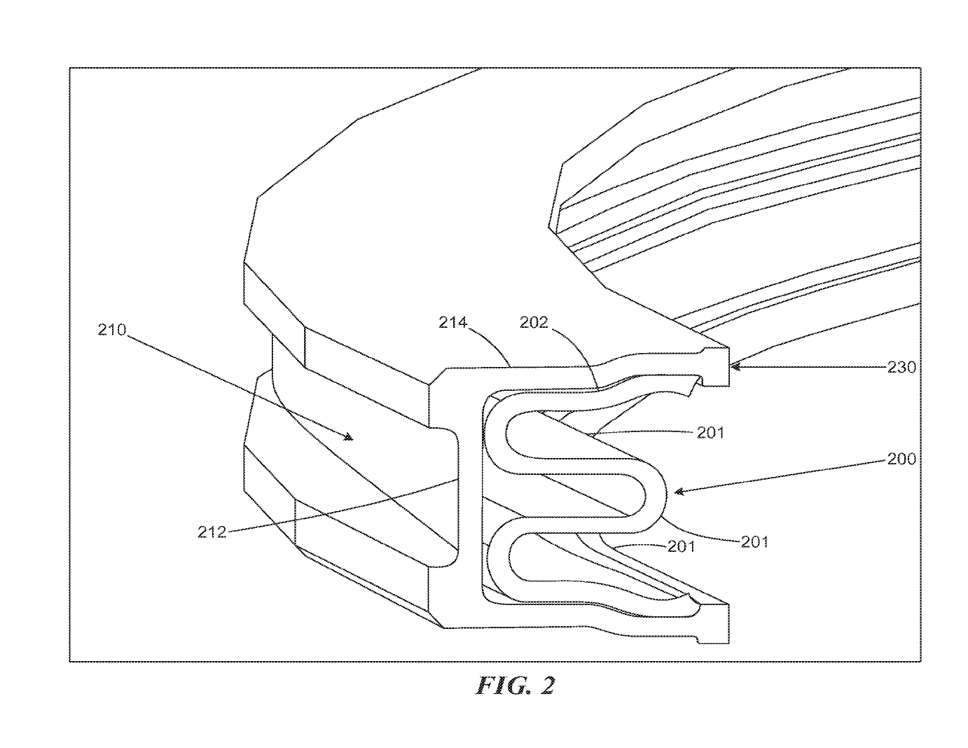

FIGS. 2-4 show various ways in which the jacket can mate with the seal. In FIG. 2, the resilient metal seal 200 is an E-seal and the jacket 210 is an exterior jacket primarily protecting the exterior surface of the resilient metal seal 200. The resilient metal seal 200 generally includes a plurality of apexes 201 where the metal of resilient metal seal 200 bends to double over on itself. Two divergent sealing arms 202 extend from one or more of the apexes 201. The sealing arms are divergent and biased away from each other such that compression of the arms 202 by the flanges (not shown) forming the sealing surface. The jacket 210 has a C-shape and has a depth and height slightly larger than the depth and height of the resilient metal seal 200 so that it can fit snuggly around the resilient metal seal 200. In particular, the jacket 210 has a wall 212 and two jacket arms 214. The jacket arms 214 abut the sealing arms 202. As shown in FIG. 2, the jacket 210 protects the exterior surface as well as the upper and lower surfaces of the resilient metal seal 200. By covering the upper and lower surfaces of the resilient metal seal 200 (i.e., the surfaces of the seal that will contact the flanges) the jacket 210 provides a layer of material that can conform to the surface of the flanges and form an improved seal.

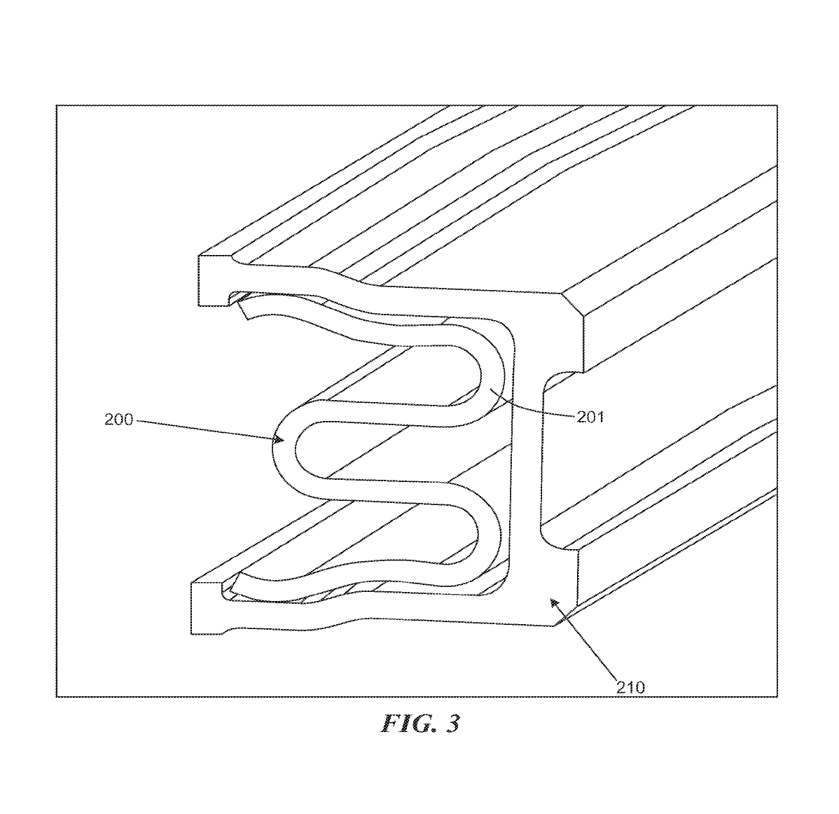

FIG. 3 shows a similar configuration to FIG. 2, with the exception that the jacket 210 is an interior jacket instead of an exterior jacket. The E-shaped resilient metal seal 200 is inverted (i.e., is a backwards E instead of the normally positioned E shown in FIG. 2), and the jacket 210 again takes the form of a C-shape that is slightly larger in height and depth so that it can snuggly fit around the resilient metal seal 200 and protect the interior surface and the top and bottom surfaces.

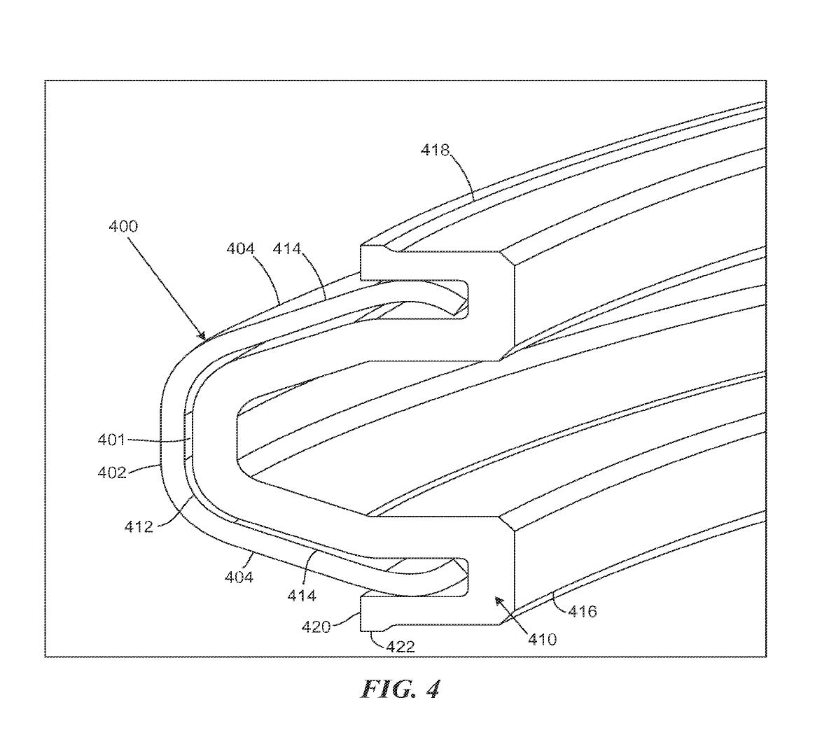

With reference to FIG. 4, a V-shaped resilient metal seal 400 is shown with an interior jacket 410. The V-shaped resilient metal seal 400 includes a wall 402 and diverging sealing arms 404 that provide the biasing force for the sealing surface. The wall 402 may be a constant curve or apex 401 instead of a flat portion. The jacket 410 has a similar V-shape as the seal 400, with the dimensions slightly altered so that it fits inside the V-shape of the seal 400 while also reaching around the top and bottom surfaces of the seal 400. Accordingly, the jacket 400 includes a wall 412 coupled to jacket arms 414. The jacket arms terminate in terminal walls 416 coupled to reverse arms 418. The terminal walls 416 and reverse arms 418 provide that the jacket 410 is between the fluid and the resilient metal seal 400. The jacket 410 need only cover the contact surfaces of the seal 400 for purposes of improving the sealing performance of the seal 400, which is why the jacket 410 only extends back a short distance over the top and bottom surfaces of the V-shaped seal 410. The terminal end 420 of the reverse arms 418 are shown with a slight bulge 422. The bulge 422 provides a reduced surface area for the jacket 410 such that the force required by the flanges to effectuate a seal is reduced. This feature is usable on the other jackets as well.

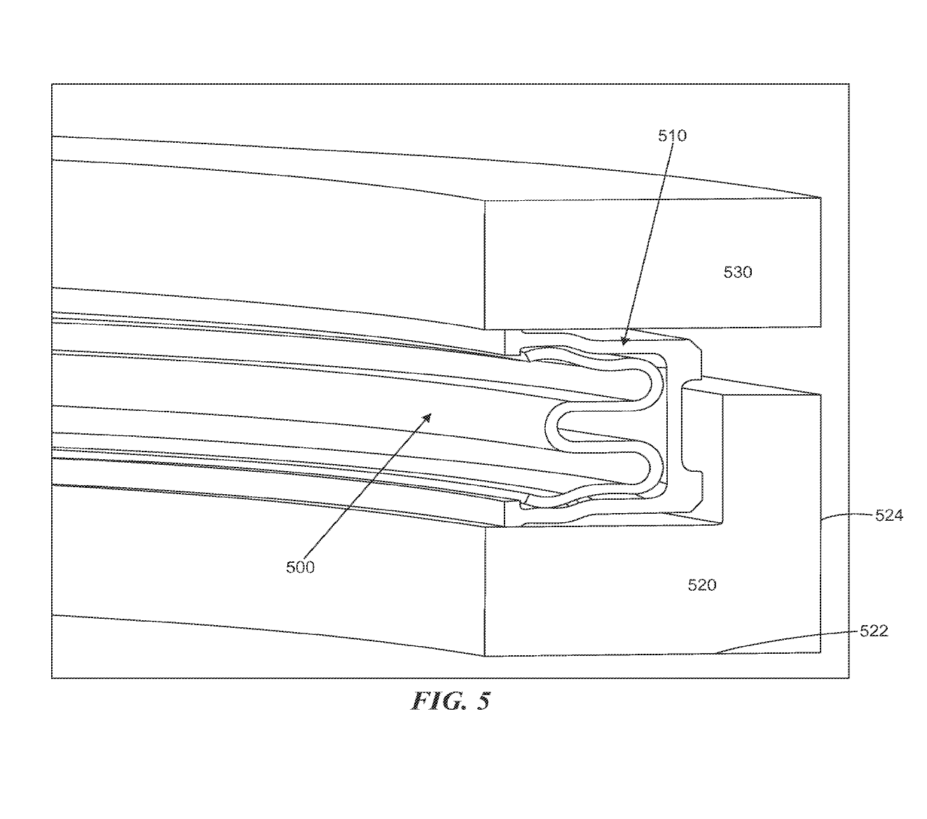

With reference to FIG. 5, the jacketed resilient metal seal shown in FIG. 2 is shown positioned between two flanges to be sealed. The E-shaped resilient metal seal 500 includes a C-shaped jacket 510 protecting the exterior surface and the top and bottom contact surfaces of the resilient metal seal 500. The bottom flange 520 has an L shape with a horizontal leg 522 and a vertical leg 524 (although horizontal and vertical are related to the orientation on the figure and should not be considered limiting) such that it contacts the jacket 510 at both the bottom surface and the exterior surface. The top flange 530 is generally flat and contacts the jacket 510 at the top surface. When the flanges 520, 530 are compressed together, the top and bottom surfaces of resilient metal seal 500 bends towards the middle of the seal 500 while pushing back on the flanges 520, 530 to create a seal. Additionally, the top and bottom surfaces of the jacket 510 conform to the surfaces of the flanges 520, 530 to create an improved seal.

Referring back to FIG. 2, the jacketed resilient metal seal is shown with the jacket 210 including a jacket locking feature 230 that helps to keep the jacket 210 from dislodging from the resilient metal seal 200. As the seal 200 is compressed between the flange surfaces, the locking feature 230 of the jacket 210 captures the sealing surface of the jacket 210, preventing it from being easily dislodged. As can be appreciated, the locking feature is a molded extension on the jacket that would snap fit to the resilient metal seal 200. In particular, the exterior wall of the jacket 210 extending over the sealing arms of the resilient metal seal would expand as the locking feature 230 moved over the resilient metal seal 200. Once the locking feature 230, or the protrusions as shown, extended past the sealing arms, the jacket would return forming a snap fit between the jacket 210 and the seal 200.

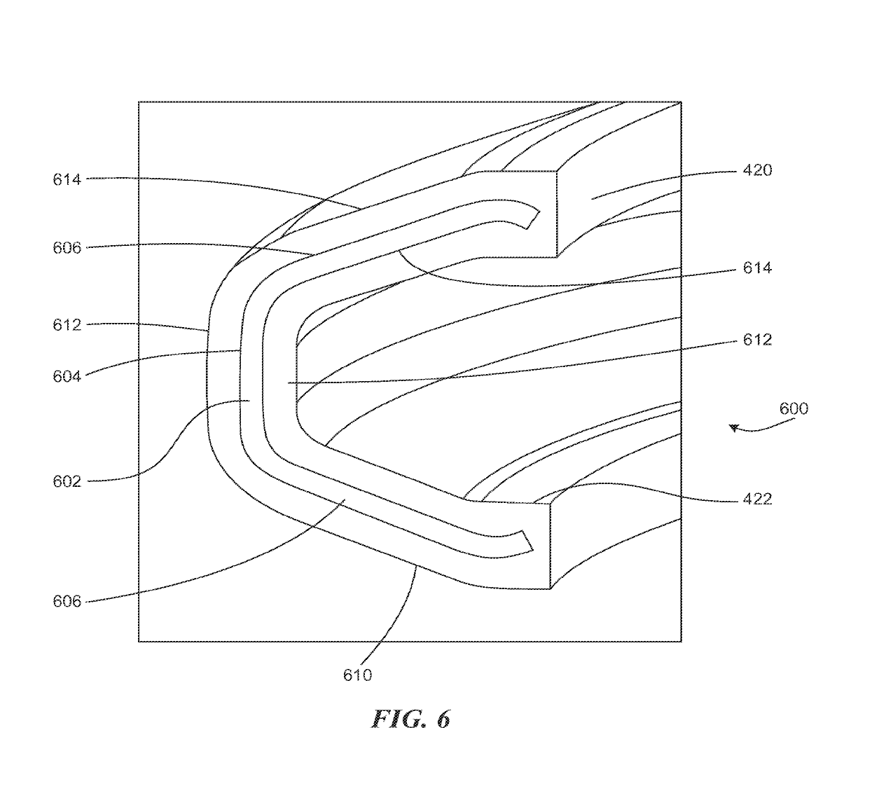

With reference to FIG. 6, a fully encapsulated resilient metal seal 600 is provided. The fully encapsulated resilient metal seal 600 includes a resilient metal seal 602, which in this embodiment is formed as a V-shaped seal having an apex 604 and a pair of divergent sealing arms 606. The fully encapsulated resilient meal seal 600 also includes a jacket 610 that encapsulated the resilient metal seal 602. The jacket 610 may be applied to the resilient metal seal 602 using a spray coating methodology or a dip coating methodology to provide a continuous, unitary jacket. The jacket 610 includes at least one apex 612 as well as a plurality of divergent jacket arms 614. The divergent jacket arms 614 may be considered on both the internal and external portions of the fully encapsulated resilient metal seal 600. Similarly, there is an internal and external apex on the jacket 610. The jacket 610 includes at least one terminal wall 616 at the end of the divergent jacket arms 614 corresponding to the lock feature described above. The lock feature 616 for the encapsulated resilient metal seal 600 comprises a connecting wall including the internal divergent jacket arms and the internal apex as shown.

Another advantage of the jacketed resilient metal seal described herein relates to the redundant protection against leaks provided by the described configurations when compared to, for example, jacketed spring-energized seals. In extreme conditions, such as fires, the jacket described herein may be consumed. However, the remaining resilient metal seal can withstand the fire and, because it is a continuous body, can continue to prevent leaks and maintain fluid within pipes sealed together by the resilient metal seal. To the contrary, when the jacket used on a spring-energized seal is consumed, the relatively open, non-continuous nature of the spring will allow for leaks. Accordingly, the presently described embodiments provide redundant protection against leaks in extreme conditions.

Unless otherwise indicated, all numbers or expressions, such as those expressing dimensions, physical characteristics, etc. used in the specification are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. An apparatus comprising:
a resilient metal seal, the resilient metal seal comprising at least one seal apex and a pair of divergent sealing arms extending from the at least one seal apex;
a jacket shaped to cooperatively engage the resilient metal seal, the jacket comprising at least one jacket apex and a pair of divergent jacket arms extending from the at least one jacket apex proximal to the pair of divergent sealing arms, and
a lock to couple the jacket and the resilient metal seal, wherein
the jacket encapsulates the resilient metal seal.

2. The apparatus of claim 1 wherein the jacket is unitary and wherein the lock comprises terminal walls on each of the divergent jacket arms and reverse arms on each of the terminal walls, wherein the reverse arms are connected.

3. The apparatus of claim 2 wherein the resilient metal seal comprises a C shape and the unitary jacket comprises a C shape.

4. An apparatus comprising:
a resilient metal seal, the resilient metal seal comprising at least one seal apex and a pair of divergent sealing arms extending from the at least one seal apex;
a jacket shaped to cooperatively engage the resilient metal seal, the jacket comprising at least one jacket apex and a pair of divergent jacket arms extending from the at least one jacket apex proximal to the pair of divergent sealing arms; and
a lock to couple the jacket and the resilient metal seal.

5. The apparatus of claim 4 wherein the resilient metal seal is an E shape and the jacket is a C shape.

6. The apparatus of claim 5 wherein the lock is formed at each end of the divergent jacket arms and the lock comprises a protrusion shaped to fit over an end of the corresponding divergent sealing arms.

7. The apparatus of claim 6 wherein the lock forms a snap fit between the jacket and the resilient metal seal.

8. The apparatus of claim 4 wherein the jacket comprises at least polytetrafluoroethylene.

9. The apparatus of claim 4 wherein the jacket comprises a material selected from the group of material consisting of: perfluoroalkoxy (PFA), fluorinated ethylene propylene (FEP), ultra high molecular weight polyethylene (UHMWPE), perfluoroelastomers, or combinations thereof.

10. The apparatus of claim 4 wherein the jacket is sized to fit externally to the resilient metal seal.

11. The apparatus of claim 4 wherein the jacket is sized to fit internally to the resilient metal seal.

12. The apparatus of claim 11 wherein the lock comprises a terminal wall and a reverse arm coupled to at least one of the divergent jacket arms, wherein the divergent jacket arm, reverse arm, and terminal wall overlay at least one of the pair of divergent sealing arms.

13. The apparatus of claim 4 wherein the resilient metal seal comprises a shape selected from a group of shapes consisting of: a C shape, a V shape, or a U shape.

14. A seal for a flanged connection comprising:
a first flange having a first surface;
a second flange having a second surface opposite the first surface separated by a distance; and
a seal abutting the first and second flange surfaces, the seal comprising:
a resilient metal seal formed into a shape where the resilient metal seal comprises opposed and divergent sealing arms;
a jacket to cooperatively engage the resilient metal seal; and
a lock to couple the resilient metal seal and the jacket.

15. The apparatus of claim 14 wherein the jacket comprises a pair of opposed and divergent jacket arms proximate the sealing arms and the lock is formed at each end of the divergent jacket arms and the lock comprises a protrusion shaped to fit over an end of the corresponding divergent sealing arms.

16. The apparatus of claim 15 wherein the lock forms a snap fit between the jacket and the resilient metal seal.

17. The apparatus of claim 14 wherein the jacket comprises at least polytetrafluoroethylene.

18. The apparatus of claim 14 wherein the jacket comprises a material selected from the group of material consisting of: perfluoroalkoxy (PFA), fluorinated ethylene propylene (FEP), ultra high molecular weight polyethylene (UHMWPE), perfluoroelastomers, or combinations thereof.

19. The apparatus of claim 14 wherein at least one of the first and second flanges comprises a horizontal element and a vertical element and wherein the jacket comprises a wall coupling the pair of divergent jacket arms wherein the vertical element abuts the wall.
